(19) United States
(12) Patent Application Publication
(10) Pub. No.: US 2009/0237958 A1
(43) Pub. Date: Sep. 24, 2009

(54) Low-clearance light-emitting diode lighting

(75) Inventor: Steven KIM, Palisades Park, NJ (US)

Correspondence Address: HOLLAND & KNIGHT LLP, 2099 PENNSYLVANIA AVE, SUITE 100, WASHINGTON, DC, 20006, US

(73) Assignee: LED Folio Corporation, Palisades Park, NJ (US)

(21) Appl. No.: 12/076,742

(22) Filed: Mar. 21, 2008

(51) Int. Cl. F21S 13/02

(52) U.S. Cl. 362/617

(57) ABSTRACT

A low-clearance light-emitting diode lighting includes a light guide panel having side surfaces and a front surface opposing a back surface, a plurality of light-emitting diodes positioned on at least two side surfaces of the light guide panel, a reflecting plate at the back surface of the light guide panel, reflectors having an inclined angle, and a metal frame for supporting the reflecting plate and the light guide panel, wherein each of the plurality of light-emitting diodes is positioned between one of the at least two side surfaces and one of the reflectors such that light from the plurality of light-emitting diodes is reflected toward the at least two side surfaces.

### BACKGROUND OF THE INVENTION

1. Field of The Invention

The present invention relates to lighting, and more particularly, to low-clearance light-emitting diode lighting. Although the present invention is suitable for a wide scope of applications, it is particularly suitable for providing low-clearance light-emitting diode lighting for either drop-ceilings, drywall/plaster ceilings or walls.

2. Discussion Of The Related Art

In general, drop-ceilings are typically installed in commercial buildings. However, drop-ceilings can also be installed in residences, such as during basement remodeling. FIG. 1A is a perspective view of a drop-ceiling having ceiling-grid with a lighting unit according to the related art. As shown in FIG. 1A, horizontal rails 1a and vertical rails 1b create a ceiling-grid 1 with openings in which ceiling tiles 2 is positioned. The ceiling-grid 1 shown in FIG. 1A is, for example, a two foot by two foot ceiling-grid. As also shown in FIG. 1A, the related art lighting unit 3, such as a fluorescent lighting fixture, can also be positioned in the ceiling-grid 1. The related art lighting unit 3 has the same standard size or outside dimensions as the ceiling tiles 2.

Drop-ceilings are easy to install because the ceiling-grid can be hung by wire-hangers, which can be readily attached to the overhead ceiling. The use of the wire-hangars permits simple installation and leveling of the drop-ceiling. A drop-ceiling covers up the electrical wires, ventilation equipment and plumbing that can run along an overhead ceiling. The electrical wires, ventilation equipment and plumbing above the drop-ceiling are easy to access through the ceiling-grid after removal of the ceiling tiles. However, a drop-ceiling requires a minimum clearance between the overhead ceiling and the drop-ceiling.

FIG. 1B is a cross-sectional view of a ceiling having ceiling-grid with a lighting unit along the line I-I′ of FIG. 1A. As shown in FIG. 1B, the back of the related art lighting unit 3, which resides in an opening of the ceiling-grid 1, extends from the ceiling-grid 1 to a lighting unit height HLU above the ceiling-grid 1. The lighting unit height HLU above the ceiling-grid 1 can be about five to six inches, depending on the depth D of the related art lighting unit 3. A minimum insertion height HMI is needed in addition to the lighting unit height HLU so as to be able to insert the related art lighting unit 3 into the ceiling-grid 1. The minimum insertion height HMI of the related art lighting unit 3 can be about four to six inches. Thus, the minimal lighting clearance height HMLC that a drop-ceiling must have to receive the related art lighting unit is the sum of the lighting unit height HLU and the minimum insertion height HMI, as shown in FIG. 1 B. Accordingly, the minimal lighting clearance height HMLC that a drop-ceiling must have to receive the related art lighting unit can be about nine to twelve inches.

Typically, the minimum clearance between an overhead ceiling and a drop-ceiling is limited by the minimal lighting clearance height HMLC of the related art lighting unit. Thus, the minimal lighting clearance height HMLC of the related art lighting unit dictates the drop-ceiling height HDC over the floor, as shown in FIG. 1B. In other words, the maximum drop-ceiling height HDC is usually limited by the minimal lighting clearance height HMLC.

Unlike drop-ceilings, a drywall/plaster ceiling is attached directly to either roof joists or floor joists. The related art lighting units in drywall/plaster ceilings are placed between the joists to accommodate the lighting unit height HLU of the related art lighting units. However, the size of the related art lighting units is limited to the spacing between floor/ceiling joists. Further, the placement of related art lighting units in a drywall/plaster ceiling is restricted because of the need for the related art lighting units to be placed between floor/ceiling joists.

Although the lighting efficiency of a light-emitting diode lighting fixture is high, heat is generated by the light-emitting diodes of a light-emitting diode lighting fixture. Removal or dissipation of such heat away from the light-emitting diodes is a determining factor in both the efficiency and the overall durability of the light-emitting diodes. However, the positioning of the light-emitting diodes may not be conducive to efficient use of the light emanating from the light-emitting diodes. Further, the addition of structures for efficient thermal dissipation may detract from the aesthetics of the fixture and impede implementation of the fixture.

### SUMMARY OF THE INVENTION

Accordingly, the present invention is directed to low-clearance lighting that substantially obviates one or more of the problems due to limitations and disadvantages of the related art.

An object of the present invention is to provide light-emitting diode lighting with low overhead clearance.

Another object of the present invention is to improve the thermal dissipation capability of light-emitting diode lighting.

Another object is to provide light-emitting diode lighting configured to reside in ceiling-grids with low overhead clearance.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the invention, as embodied and broadly described, a low-clearance light-emitting diode lighting includes a light guide panel having side surfaces and a front surface opposing a back surface, a plurality of light-emitting diodes positioned on at least two side surfaces of the light guide panel, a reflecting plate at the back surface of the light guide panel, reflectors having an inclined angle, and a metal frame for supporting the reflecting plate and the light guide panel, wherein each of the plurality of light-emitting diodes is positioned between one of the at least two side surfaces and one of the reflectors such that light from the plurality of light-emitting diodes is reflected toward the at least two side surfaces.

In another aspect, a low-clearance light-emitting diode lighting includes a light guide panel having side surfaces and a front surface opposing a back surface, a plurality of light-emitting diodes positioned on at least two side surfaces of the light guide panel, and a reflective encasement having an interior reflective surface at back surface of the light guide panel and interior reflective surfaces having an inclined angle, wherein each of the plurality of light-emitting diodes is positioned between one of the at least two side surfaces and one of the inclined interior reflective surfaces such that light from the plurality of light-emitting diodes is reflected toward the at least two side surfaces.

In another aspect, a low-clearance light-emitting diode lighting includes a light guide panel having side surfaces and a front surface opposing a back surface, a reflecting plate at the back surface of the light guide panel, reflectors having an inclined angle, and a plurality of light-emitting diodes positioned on at least two side surfaces of the light guide panel and mounted on the reflecting plate, wherein each of the plurality of light-emitting diodes is positioned between one of the at least two side surfaces and one of the reflectors such that light from the plurality of light-emitting diodes is reflected toward the at least two side surfaces.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1A is a perspective view of a lighting unit in the ceiling-grid of a drop-ceiling according to the related art;

FIG. 1B is a cross-sectional view along the line I-I′ of FIG. 1A;

FIG. 2A is a perspective view of a ceiling-grid with a low-clearance light-emitting diode lighting unit according to embodiments of the invention;

FIG. 2B is a cross-sectional view along the line II-II′ of FIG. 2A;

FIG. 3 is a top view of a low-clearance light-emitting diode lighting unit shown in FIGS. 2A-2B;

FIG. 4A is a side view of the light tile shown in FIG. 3 according to a first embodiment of the invention;

FIG. 4B is an exploded view of the circle III shown in FIG. 4A;

FIG. 5A is a side view of the light tile shown in FIG. 3 according to a second embodiment of the invention;

FIG. 5B is an exploded view of the circle IV shown in FIG. 5A;

FIG. 6A is a cross-sectional view of a low-clearance light-emitting diode lighting unit according to a third embodiment of the invention;

FIG. 6B is an exploded view of the circle V shown in FIG. 6A;

FIG. 7A is a cross-sectional view of a low-clearance light-emitting diode lighting unit according to a fourth embodiment of the invention;

FIG. 7B is an exploded view of the circle VI shown in FIG. 6A;

FIG. 8A is a perspective view of a drywall/plaster ceiling having a low-clearance light-emitting diode lighting unit according to a fifth embodiment of the invention;

FIG. 8B is a cross-sectional view of along the line VII-VII′ of FIG. 8A;

FIG. 9A is a bottom view of a circular LED lighting fixture;

FIG. 9B is a side view of the circular LED lighting fixture shown in FIG. 9A;

FIG. 10 is a hexagonal-shaped low-clearance light-emitting diode lighting unit according to a sixth embodiment of the invention; and

FIG. 11 is a trapezoidal-shaped low-clearance light-emitting diode lighting unit according to a seventh embodiment of the invention.

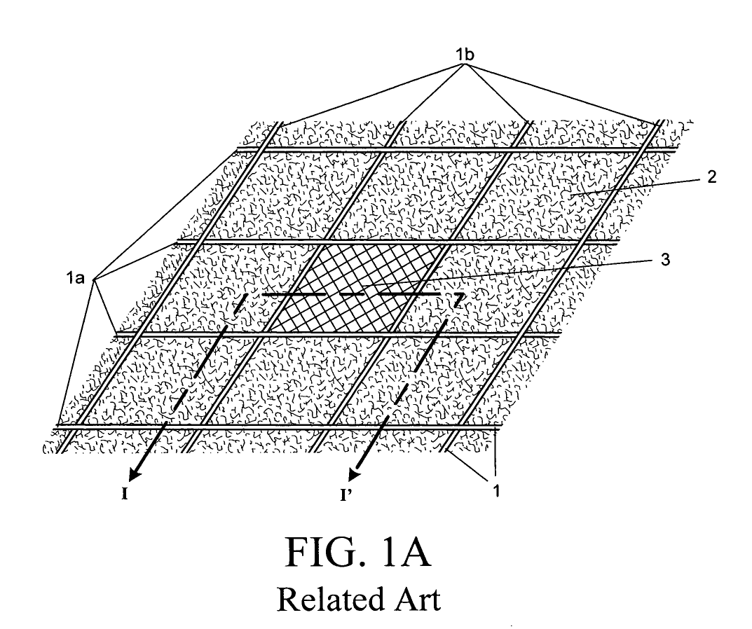

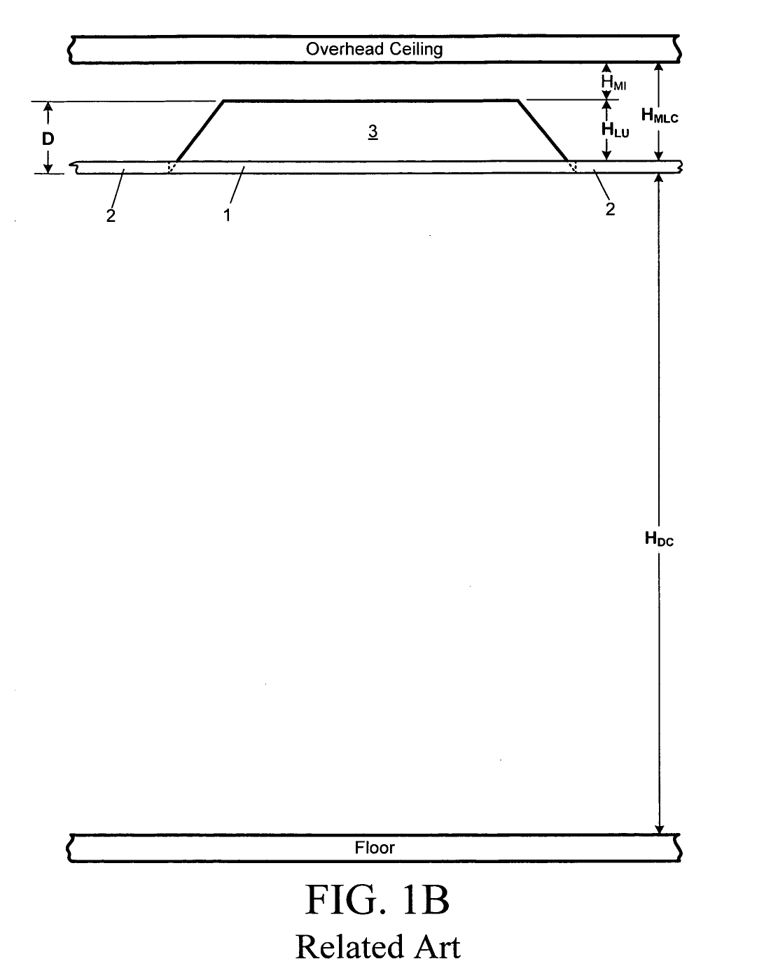

### DETAILED DESCRIPTION OF THE PREFERRED EMBODIMENTS

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

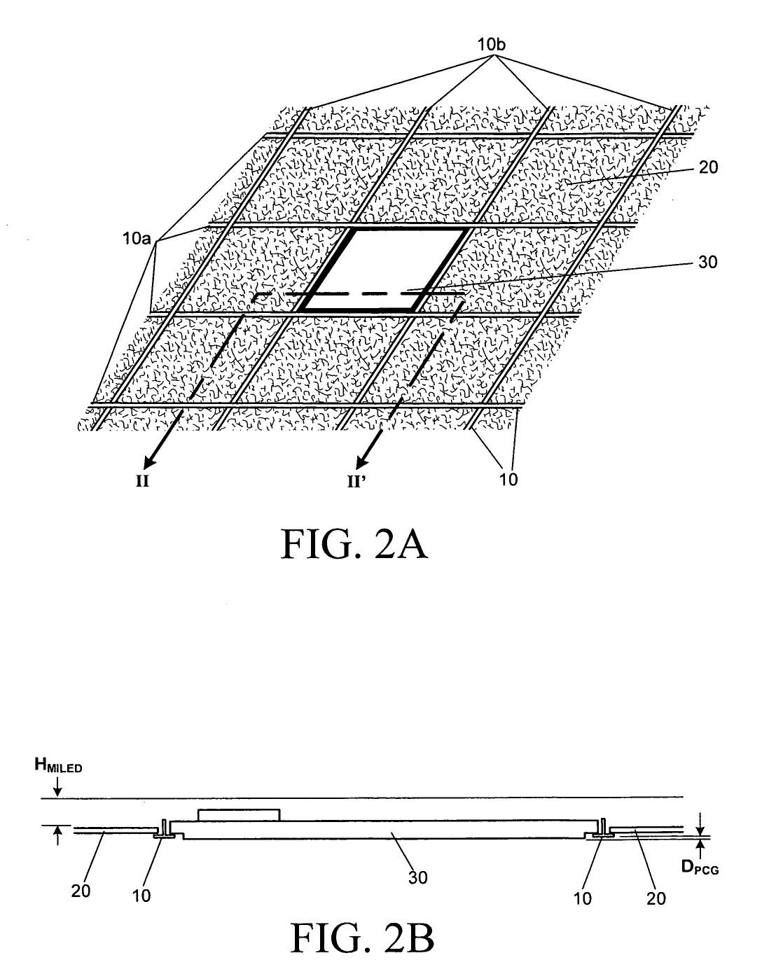

FIG. 2A is a perspective view of a ceiling-grid with a low-clearance light-emitting diode lighting unit according to a first embodiment of the invention. As shown in FIG. 2A, horizontal rails 10a and vertical rails 10b create a ceiling-grid 10 having openings in which ceiling tiles 20 are positioned. The ceiling-grid 10 shown in FIG. 2A is, for example, a two foot by two foot ceiling-grid 10. As also shown in FIG. 2A, a low-clearance light-emitting diode lighting unit 30 is positioned in an opening of the ceiling-grid 10. The low-clearance light-emitting diode lighting unit 30 has a similar size or outside dimensions as the ceiling tiles 20. Although a two foot by two foot ceiling-grid 10 is shown in FIG. 2A, embodiments of the invention can be implemented in two foot by four foot grid as well as grids of other sizes.

FIG. 2B is a cross-sectional view of a ceiling-grid with a lighting unit along the line II-II′ of FIG. 2A. As shown in FIG. 2B, the low-clearance light-emitting diode lighting unit 30, which resides in an opening of the ceiling-grid 10, may extend above the ceiling-grid 10 because of a power supply 36 mounted at the back of the low-clearance light-emitting diode lighting unit 30. Further, the low-clearance light-emitting diode lighting unit 30 may have profile such that a portion of the low-clearance light-emitting diode lighting unit 30 protrudes slightly with a protrusion distance DPCG from the ceiling-grid 10.

As shown in FIG. 2B, the low-clearance light-emitting diode lighting unit 30 has a minimum insertion height HMILED so as to be able to insert the low-clearance light-emitting diode lighting unit 30 into the ceiling-grid 10. The minimum insertion height HMILED can be about one to three inches for a light-emitting diode lighting unit 30 without a power supply and about two to four inches for light-emitting diode lighting unit 30 with a power supply. Thus, the minimal lighting clearance height that a drop-ceiling must have to receive the low-clearance light-emitting diode lighting unit 30 is just the minimum insertion height HMILED of the low-clearance light-emitting diode lighting unit 30. The low-clearance light-emitting diode lighting unit of embodiments of the invention can increase the height between the floor and the low-clearance light-emitting diode lighting unit so as to raise a drop-ceiling by decreasing the lighting clearance height to about two to four inches.

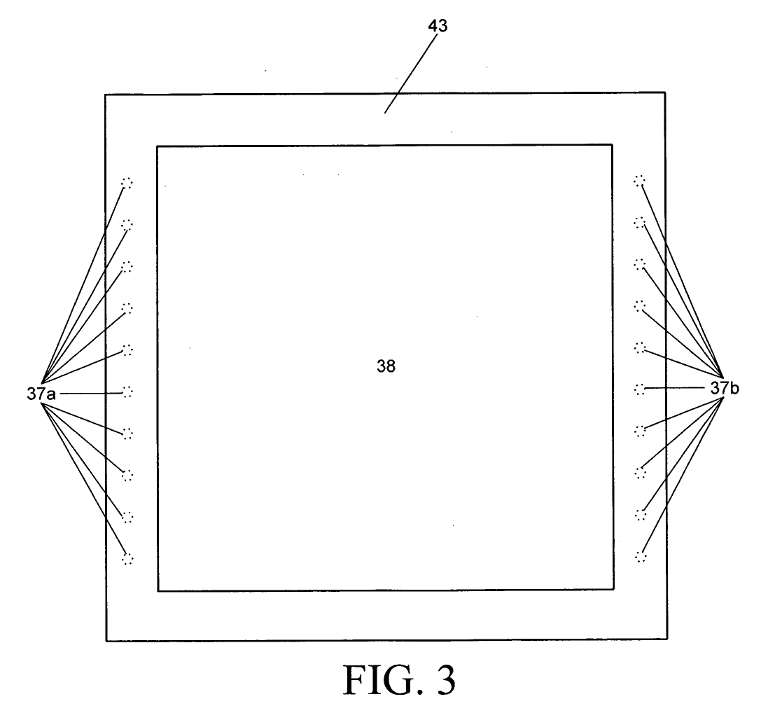

FIG. 3 is a top view of a low-clearance light-emitting diode lighting unit shown in FIGS. 2A-2B. As shown in FIG. 3, a light guide panel 38 is surrounded by a frame 43. A first set of light-emitting diodes 37a is positioned on one side of the low-clearance light-emitting diode lighting unit within the frame 43 and a second set of light diodes 37b is position at a second side of the low-clearance light-emitting diode lighting unit 33 within the frame 43. The first and second sets of light-emitting diodes 37a and 37b can be on opposite sides of the low-clearance light-emitting diode lighting unit. Although the first and second sets of light-emitting diodes 37a and 37b are shown directly opposing each other in FIG. 3, the first and second sets of light-emitting diodes 37a and 37b can be on opposite sides of the low-clearance light-emitting diode lighting unit but yet offset from one another. Further, an additional set or sets of light-emitting diodes can be provided at another side or other sides of the low-clearance light-emitting diode lighting unit for increased light output.

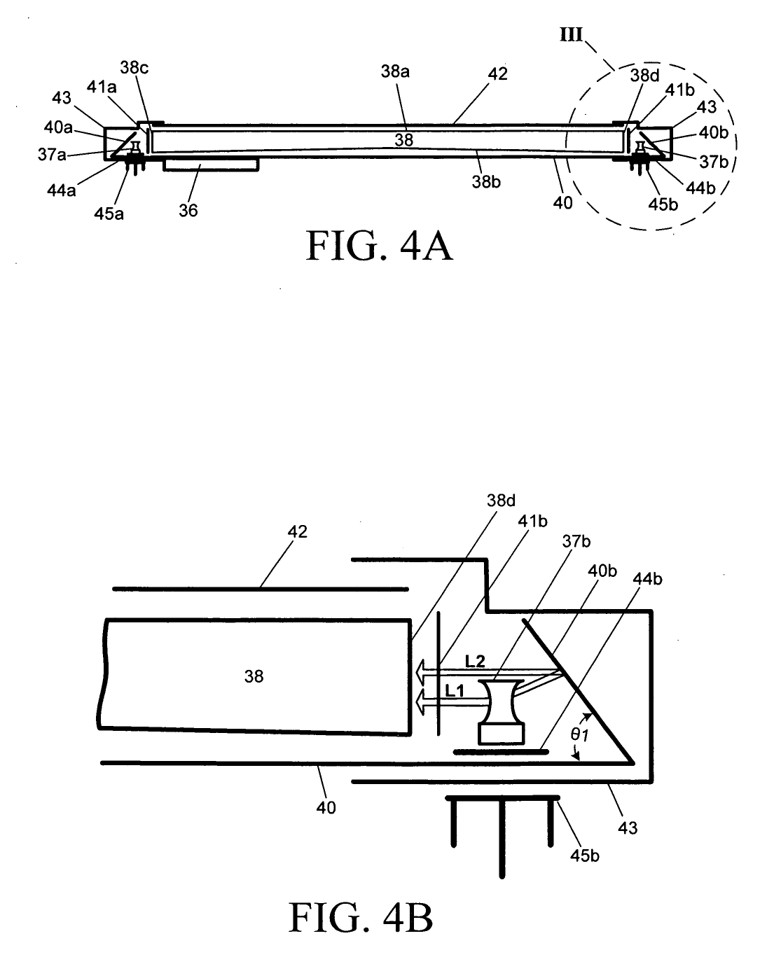

FIG. 4A is a side view of the light tile shown in FIG. 3 according to a first embodiment of the invention. As shown in FIG. 4A, a low-clearance light-emitting diode lighting unit can include a light guide panel 38 for receiving light from the side light-emitting diodes 37a and 37b and then distributing the light across the front surface 38a of the light guide panel 38. A reflective plate 40 on the back surface 38b of the light guide panel 38 reflects light toward the front surface 38a of the light guide panel 38. The side light-emitting diodes 37a and 37b are mounted on the reflective plate 40 within the frame 43. Reflectors 40a and 40b, which are an integral part of the reflective plate 40, reflect light from the side light-emitting diodes 37a and 37b toward the two side surfaces 38c and 38d of the light guide panel 38. Finned heatsinks 45a and 45b are mounted on the frame 43 adjacent to the side light-emitting diodes 37a and 37b to dissipate heat generated by the side light-emitting diodes 37a and 37b. Heat dispersers 44a and 44b between the side light-emitting diodes 37a and 37b and the frame 43 increase thermal transfer from the light-emitting diodes 37a and 37b to the finned heatsinks 45a and 45b. A diffusion film 42 can be positioned directly on the front surface 38a of the light guide panel 38 to increase light dispersion. A power supply 36 can be mounted on the reflective plate 40 under the back surface 38b of the light guide panel 38 for converting 120 VAC to 12 VDC to drive the side light-emitting diodes 37a and 37b.

The side light-emitting diodes 37a and 37b can be white light-emitting diodes. In the alternative, the side light-emitting diodes 37a and 37b can include red, blue and green light-emitting diodes that are positioned along the sides of the light guide panel 38 such that the red, blue and green lights from the red, blue and green light-emitting diodes combines into white light. In another alternative, the side light-emitting diodes 37a and 37b can be blue light-emitting diodes. In yet another alternative, the side light-emitting diodes 37a and 37b can be ultraviolet light-emitting diodes. In the cases of blue light-emitting diodes and ultraviolet light-emitting diodes, a color conversion structure is needed to convert the blue light or the ultraviolet light into white light.

As shown in FIG. 4A, a pair of color conversion films 41a and 41b can be positioned at the two side surfaces 38c and 38d of the light guide panel 38. More specifically, the pair of color conversion films 41a and 41b can be positioned between the two side surfaces 38c and 38d of the light guide panel 38 and the side light-emitting diodes 37a and 37b. The color conversion films 41a and 41b can convert ultraviolet light or blue light from the side light-emitting diodes 37a and 37b to white light.

The side light-emitting diodes 37a and 37b can be configured to emit light in 360 degrees or emit light in two opposing 90 degree arcs. If the side light-emitting diodes 37a and 37b are configured to emit light in two opposing 90 degree arcs, one of the arcs is centered on one of the at least two side surfaces 38c and 38d of the light guide panel 38. In the alternative, the top light-emitting diodes 37a and 37b can be used that emit light directly toward the reflectors 40a and 40b.

FIG. 4B is an exploded view of the circle III shown in FIG. 4A. As shown in FIG. 4B, the reflector 40b is at an angle θ1 of inclination with respect to the reflective plate 40. The angle θ1 can be within a range of thirty to eighty-five degrees. The angle θ1 of inclination tends to be greater for side light-emitting diodes than top light-emitting diodes. Since the light-emitting diode 37b is a side light-emitting diode and the reflector 40b is at an angle Θ1 with respect to the reflective plate 40, a first light L4 and L5 is emitted directly toward the side surface 38d of the light guide panel 38 from the side light-emitting diode 37b while a second light L2 is reflected from the reflector 40b toward the side surface 38d of the light guide panel 38.

As shown in FIG. 4B, a finned heatsink 45b is positioned directly under and adjacent to the light-emitting diode 37b on the underside of the frame 43. Heat from the light-emitting diode 37b is transferred through the reflective plate 40 and the frame 43 to the finned heatsink 45b. To increase the thermal efficiency of heat transfer from the side light-emitting diode 37b, a heat disperser 44b can be positioned between light-emitting diode 37b and the reflective plate 40. The heat disperser 44b can be made of a thermally conductive, such as copper, aluminum or steel, and can be in the form of a strip on which a plurality of the side light-emitting diodes 37b are mounted.

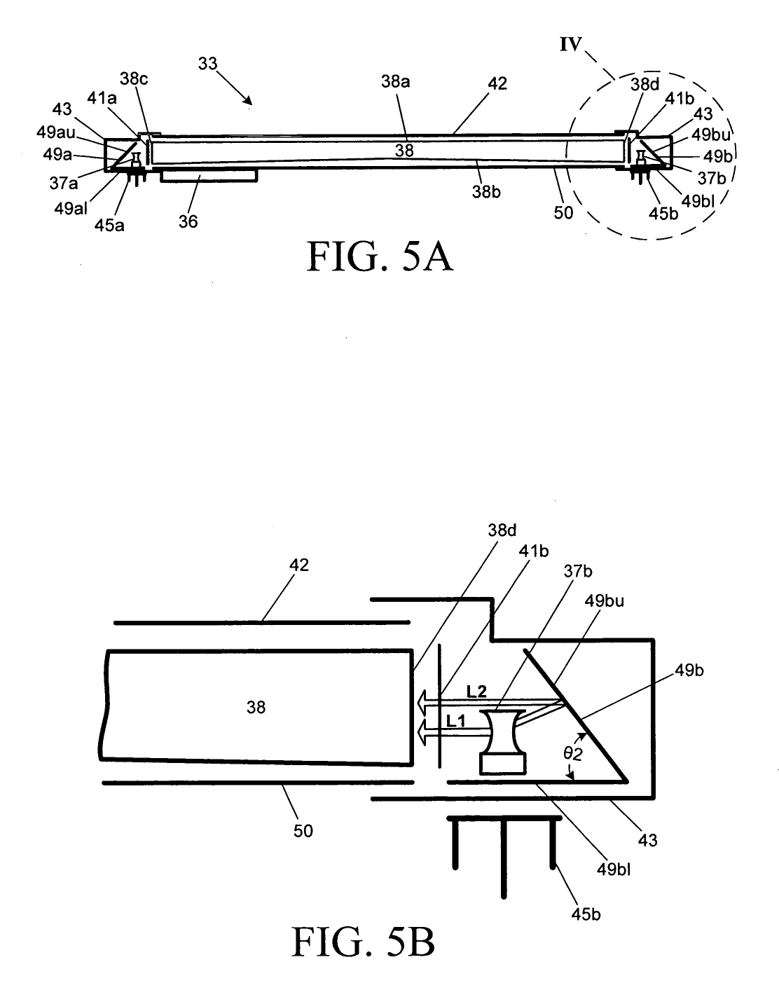

FIG. 5A is a side view of the light tile shown in FIG. 3 according to a second embodiment of the invention. As shown in FIG. 5, a low-clearance light-emitting diode lighting unit can include a light guide panel 38 for receiving light from the side light-emitting diodes 37a and 37b and then distributing the light across the front surface 38a of the light guide panel 38. A reflective plate 50 on the back surface 38b of the light guide panel 38 reflects light toward the front surface 38a of the light guide panel 38. The side light-emitting diodes 37a and 37b are mounted within the frame 43. Reflectors 49au and 49bu reflect light from the side light-emitting diodes 37a and 37b toward the two side surfaces 38c and 38d of the light guide panel 38. Finned heatsinks 45a and 45b are mounted on the frame 43 adjacent to the side light-emitting diodes 37a and 37b to dissipate heat generated by the side light-emitting diodes 37a and 37b. Heat dispersers 49a1 and 49b1 between the side light-emitting diodes 37a and 37b and the frame 43 increase thermal transfer from the side light-emitting diodes 37a and 37b to the finned heatsinks 45a and 45b. A diffusion film 42 can be positioned directly on the front surfaces 38a of the light guide panel 38 to increase light dispersion. A power supply 36 can be mounted on the reflective plate 50 under the back surface 38b of the light guide panel 38 for converting 120 VAC to 12 VDC to drive the side light-emitting diodes 37a and 37b.

FIG. 5B is an exploded view of the circle IV shown in FIG. 5A. As shown in FIG. 5B, the reflector 49bu is at an angle θ2 of inclination with respect to the heat disperser 49b1. The angle θ2 can be within a range of thirty to eighty-five degrees. The angle θ2 of inclination tends to be greater for side light-emitting diodes than top light-emitting diodes. Since the light-emitting diode 37b is a side light-emitting diode and the reflector 49bu is at an angle θ2 with respect to the heat disperser 49b1, a first light L4 and L5 is emitted directly toward the side surface 38d of the light guide panel 38 from the side light-emitting diode 37b while a second light L2 is reflected from the reflector 49bu toward the side surface 38d of the light guide panel 38.

As shown in FIG. 5B, a finned heatsink 45b is positioned directly under and adjacent to the light-emitting diode 37b on the underside of the frame 43. Heat from the side light-emitting diode 37b is transferred through the frame 43 to the finned heatsink 45b. To increase the thermal efficiency of heat transfer from the side light-emitting diode 37b, a heat disperser 49b1 can be positioned between side light-emitting diode 37b and the frame 43. The heat disperser 49b1 can be made of a thermally conductive, such as copper, aluminum or steel, and can be in the form of a strip on which a plurality of the side light-emitting diodes 37b are mounted. The reflector 49bu can be an integral part of the heat disperser 49b1. As shown in FIG. 5B, the reflector 49bu is separate from the reflective plate 50.

The first and second embodiments of the invention shown in FIGS. 4A, 4B, 5A and 5B have a frame for attaching the reflective plate, light guide panel and the diffusion film together. In both the first and second embodiments, the reflectors are within the frame. Third and fourth embodiments of the invention include an encasement, which is both a reflective plate and reflectors, attaching the light guide panel and the diffusion film together such that the interior surface of the encasement is a reflector for the light guide panel and the light-emitting diodes mounted on the encasement.

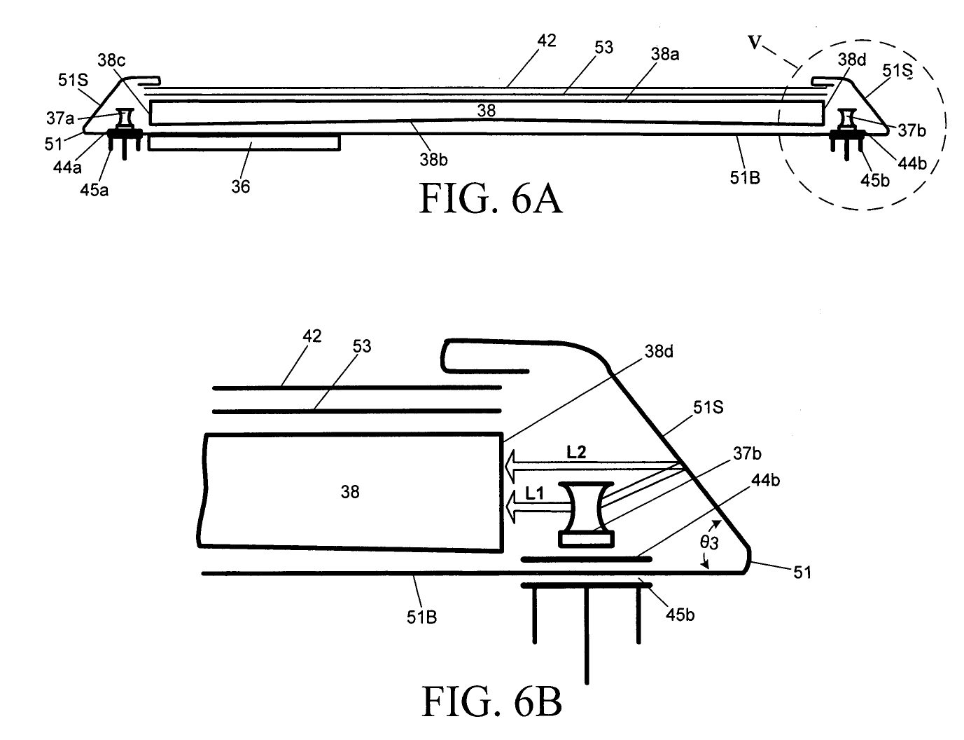

FIG. 6A is a cross-sectional view of a low-clearance light-emitting diode lighting unit according to a third embodiment of the invention. As shown in FIG. 6A, a low-clearance light-emitting diode lighting unit can include a light guide panel 38 for receiving light from the side light-emitting diodes 37a and 37b and then distributing the light across the front surface 38a of the light guide panel 38. An encasement 51 includes a back reflector part 51B having an interior reflective surface at back surface 38b of the light guide panel 38 that reflects light toward the front surface 38a of the light guide panel 38 and side reflectors 51S having an interior reflective surfaces that reflect light from the side light-emitting diodes 37a and 37b toward the two side surfaces 38c and 38d of the light guide panel 38. Finned heatsinks 45a and 45b are mounted on the encasement 51 adjacent to the side light-emitting diodes 37a and 37b to dissipate heat generated by the side light-emitting diodes 37a and 37b. Heat dispersers 44a and 44b between the side light-emitting diodes 37a and 37b and the encasement 51 increase thermal transfer from the side light-emitting diodes 37a and 37b to the finned heatsinks 45a and 45b. A color conversion film 53 can be positioned directly on the front surface 38a of the light guide panel 38 to convert blue or ultraviolet light from the side light-emitting diodes 37a and 37b into white light. A diffusion film 42 can be positioned directly on the color conversion film 53 to increase light dispersion. A power supply 36 can be mounted on the encasement 51 under the back surface 38b of the light guide panel 38 for converting 120 VAC to 12 VDC to drive the side light-emitting diodes 37a and 37b.

FIG. 6B is an exploded view of the circle V shown in FIG. 6A. As shown in FIG. 6A, the side reflector 51S of the encasement 51 is at an angle θ3 of inclination with respect to the back reflector part 51B of the encasement 51. The angle θ3 can be within a range of thirty to eighty-five degrees. Since the light-emitting diode 37b is a side light-emitting diode and the side reflector 51S of the encasement 51 is at an angle θ3 with respect to the back reflector part 51B of the encasement 51, a first light L4 and L5 is emitted directly toward the side surface 38d of the light guide panel 38 from the side light-emitting diode 37b while a second light L2 is reflected from the side reflector 51S, which is an interior side surface of the encasement 51, toward the side surface 38d of the light guide panel 38.

As shown in FIG. 6B, a finned heatsink 45b is positioned directly under and adjacent to the side light-emitting diode 37b on the underside the back reflector part 51B of the encasement 51. Heat from the side light-emitting diode 37b is transferred through the back reflector part 51B of the encasement 51 to the finned heatsink 45b. To increase the thermal efficiency of heat transfer from the side light-emitting diode 37b, a heat disperser 44b can be positioned between side light-emitting diode 37b and the back reflector part 51B of the encasement 51. The heat disperser 44b can be made of a thermally conductive, such as copper, aluminum or steel, and can be in the form of a strip on which a plurality of the side light-emitting diodes 37b are mounted. As shown in FIG. 6B, the side reflector 51S is integral with the back reflector part 51B.

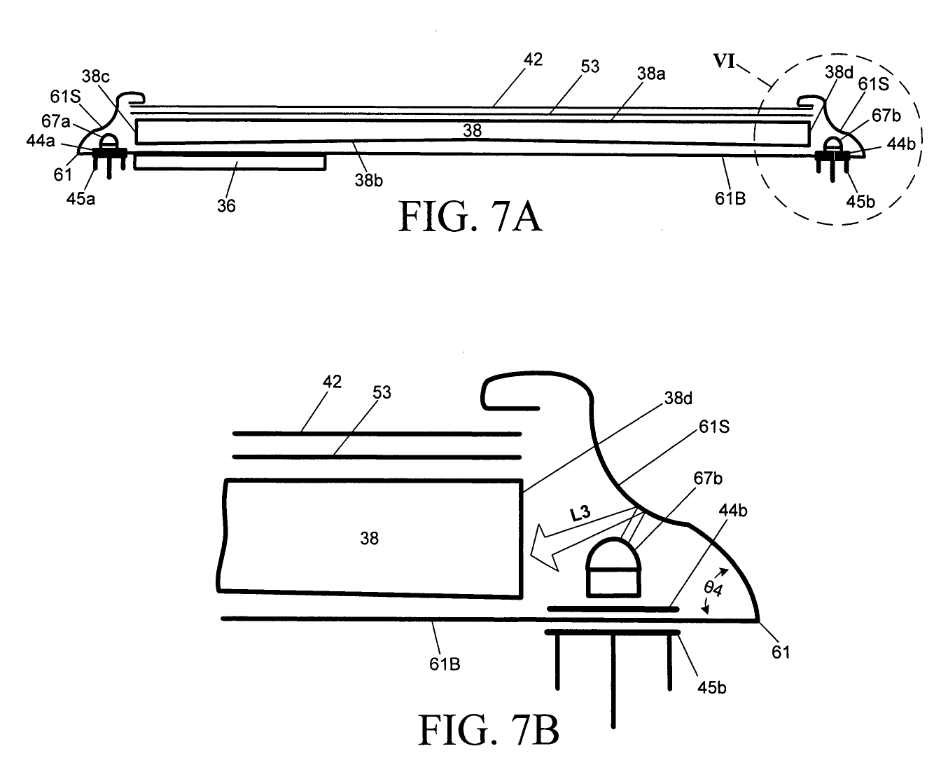

FIG. 7A is a cross-sectional view of a low-clearance light-emitting diode lighting unit according to a fourth embodiment of the invention. As shown in FIG. 7A, a low-clearance light-emitting diode lighting unit can include a light guide panel 38 for receiving light from the top light-emitting diodes 67a and 67b and then distributing the light across the front surface 38a of the light guide panel 38. An encasement 61 includes a back reflector part 61B having an interior reflective surface at back surface 38b of the light guide panel 38 that reflects light toward the front surface 38a of the light guide panel 38 and side reflectors 61S having interior reflective surfaces that reflect light from the top light-emitting diodes 67a and 67b toward the two side surfaces 38c and 38d of the light guide panel 38. Finned heatsinks 45a and 45b are mounted on the encasement 61 adjacent to the top light-emitting diodes 67a and 67b to dissipate heat generated by the top light-emitting diodes 67a and 67b. Heat dispersers 44a and 44b between the top light-emitting diodes 67a and 67b and the encasement 61 increase thermal transfer from the top light-emitting diodes 67a and 67b to the finned heatsinks 45a and 45b. A color conversion film 53 can be positioned directly on the front surface 38a of the light guide panel 38 to convert blue or ultraviolet light from the top light-emitting diodes 67a and 67b into white light. A diffusion film 42 can be positioned directly on the color conversion film 53 to increase light dispersion. A power supply 36 can be mounted on the encasement 61 under the back surface 38b of the light guide panel 38 for converting 120 VAC to 12 VDC to drive the top light-emitting diodes 67a and 67b.

FIG. 7B is an exploded view of the circle VI shown in FIG. 6A. As shown in FIG. 7A, the side reflector 61S of the encasement 61 is at an angle θ4 of inclination with respect to the back reflector part 61B of the encasement 61. The angle θ4 can be within a range of twenty to sixty degrees. The interior surface of the side reflector 61S of the encasement 61 has a convex shape. Since the light-emitting diode 67b is a top light-emitting diode and the convex-shaped side reflector 61S of the encasement 61 is at an angle θ4 with respect to the back reflector part 61B of the encasement 61, light L3 is reflected from the side reflector 61S so that the reflected light L3 spreads out toward the side surface 38d of the light guide panel 38.

As shown in FIG. 7B, a finned heatsink 45b is positioned directly under and adjacent to the top light-emitting diode 67b on the underside the back reflector part 61B of the encasement 61. Heat from the top light-emitting diode 67b is transferred through the back reflector part 61B of the encasement 61 to the finned heatsink 45b. To increase the thermal efficiency of heat transfer from the top light-emitting diode 67b, a heat disperser 44b can be positioned between the top light-emitting diode 67b and the back reflector part 61B of the encasement 61. The heat disperser 44b can be made of a thermally conductive, such as copper, aluminum or steel, and can be in the form of a strip on which a plurality of the top light-emitting diodes 67b are mounted. As shown in FIG. 7B, the side reflector 61S is integral with the back reflector part 61B.

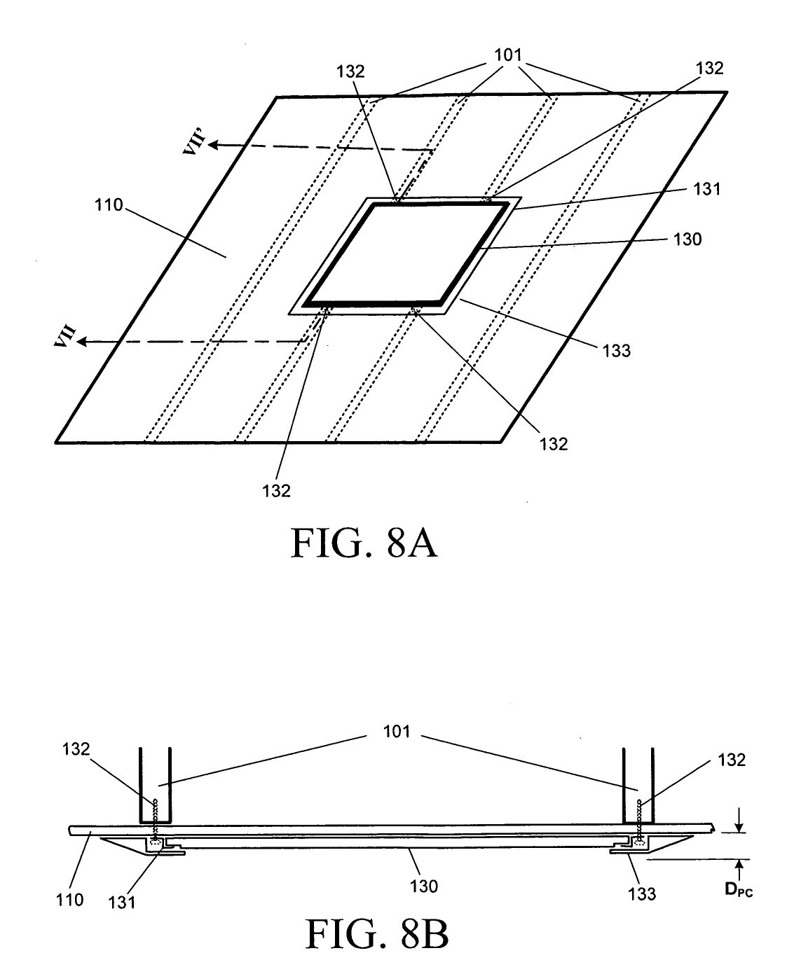

FIG. 8A is a perspective view of a drywall/plaster ceiling having a low-clearance light-emitting diode lighting unit according to a fifth embodiment of the invention. As shown in FIG. 8A, ceiling joists 101 support a ceiling 110, such as a drywall or plaster ceiling. As also shown in FIG. 8A, a low-clearance light-emitting diode lighting unit 130 is mounted on the ceiling 110. A trim piece cover 133 about the periphery of the low-clearance light-emitting diode lighting unit 130 covers the mounting hardware 132.

FIG. 8B is a cross-sectional view of along the line VII-VII′ of FIG. 8A. As shown in FIG. 8B, the mounting hardware 132 can include a bracket 131 and a lag screw 132. The bracket 131 is positioned on the light-emitting diode lighting unit 130, and then the lag screw 132 goes through bracket 131 into a joist 101 so as to attach the low-clearance light-emitting diode lighting unit 130 to the ceiling 110. The low-clearance light-emitting diode lighting unit 130 can be attached to two ceiling joists 101 through the ceiling 110, as shown in FIG. 8B. Alternatively, the low-clearance light-emitting diode lighting unit 130 can be attached to just one ceiling joist. Further, the low-clearance light-emitting diode lighting unit 130 could just be attached directly to the ceiling 110.

Although the fifth embodiment of the invention is described with regard to mounting a low-clearance light-emitting diode lighting unit on a ceiling, the low-clearance light-emitting diode lighting unit of the fifth embodiment can also be mounted on a wall. Instead of ceiling joists, the low-clearance light-emitting diode lighting unit of the fifth embodiment can be attached to the wall studs of a wall or just directly attached to a wall. Further, the low-clearance light-emitting diode lighting unit of the fifth embodiment can be mounted directly on the ceiling joists such that the low-clearance light-emitting diode lighting unit of the fifth embodiment is slightly recessed into the ceiling. Furthermore, the low-clearance light-emitting diode lighting unit of the fifth embodiment can be mounted directly on the wall studs such that the low-clearance light-emitting diode lighting unit of the fifth embodiment is slightly recessed into the wall.

The low-clearance light-emitting diode lighting unit 130 shown in FIG. 8B only has a protrusion distance DPC from the ceiling of about one to three inches. Thus, the low-clearance light-emitting diode lighting unit 130 can be mounted on a ceiling 110 without significantly affecting the overall height between the floor and the low-clearance light-emitting diode lighting unit 130. The low-clearance light-emitting diode lighting unit of the fifth embodiment of the invention allows for more freedom in the placement of the lighting unit in that the low-clearance light-emitting diode lighting unit can be mounted anywhere on a ceiling. Further, the low-clearance light-emitting diode lighting unit of the fifth embodiment can be mounted on a wall without significantly protruding from the wall.

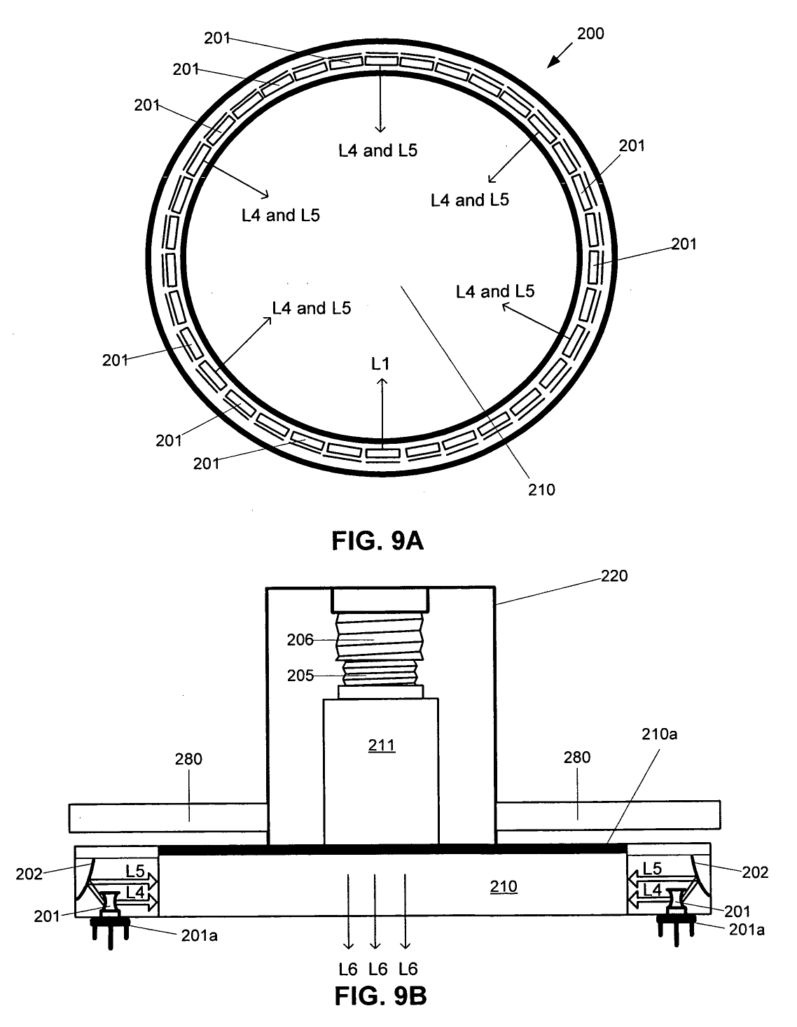

FIG. 9A is a bottom view of a circular LED lighting fixture and FIG. 9B is a side view of the circular LED lighting fixture shown in FIG. 9A. As shown in FIG. 9A, the circular LED lighting fixture 200 has a light guide panel 210 at its center. The light guide panel 210 is surrounded by light emitting diodes 201 that emit light L4 and L5 into the light guide panel 210, as shown in FIG. 9A. The light guide panel 210 is made from both transparent and partially transparent polymers. As shown in FIG. 9A and FIG. 9B, the light emitting diodes 201 emit light L4 and L5 that enters the light guide panel 210 in a radially inward direction. As shown in FIG. 9A, each light-emitting diode 201 is adjacent to reflector 202, that redirects light emitted by the light-emitting diode 201 towards the light guide panel 210.

The redirection of light by the reflector 202 is shown in more detail in FIG. 9B. As shown in FIG. 9B, light L5 has been emitted by light-emitting diode 201 and redirected by the reflector 202 towards the light guide panel 210. Ultimately, the light guide panel 210 redirects light L4 and L5 emitted by the light emitting diodes, as shown in FIG. 9B, out of the circular LED lighting fixture 200 as light L6. As also shown in FIG. 9B, a finned heatsink 201a is positioned directly under and adjacent to the light-emitting diode 201. Heat from the light-emitting diode 201 is transferred to the finned heatsink 201a. To increase the thermal efficiency of heat transfer from the light-emitting diode 201, a heat disperser (not shown) can be positioned on the light-emitting diode 201. The heat disperser (not shown) can be made of a thermally conductive material, such as copper, aluminum or steel, and can be in the form of a strip on which a plurality of the light-emitting diode 201 are mounted.

The circular LED lighting fixture 200 of FIGS. 9A and 9B has a power supply 211 and fits in the recessed can lighting fixture 220. The circular LED lighting fixture 200 is circular or disk shaped, as shown in FIG. 9A and FIG. 9B. In the alternative, the LED lighting fixture 200 can have one of a number of other shapes, such as that of an ellipse, polygon or annulus. As shown in FIG. 9A and FIG. 9B, a mirrored top surface 210a of the circular LED lighting fixture 200 reflects light L4 and L5 emitted by the light emitting diodes 201. The mirrored top surface 210a can be a reflective layer 210a that is separate from the light guide panel 210. Alternatively, the mirrored top surface 210a is a reflective layer 210a on the light guide panel 210 of a reflective material, such as a metal. The mirrored top surface 210a can be opaque and reflective to the light L4 and L5 emitted by the light emitting diodes 201. Alternatively, the mirrored top surface 210a is partially transmissive to the light L4 and L5 emitted by the light emitting diodes 201. As shown in FIG. 9A and FIG. 9B, light L4 and L5 emitted by the light emitting diodes 201 and reflected from the mirrored top surface 210a leaves the circular LED lighting fixture 200 through the bottom surface 210b of the circular LED lighting fixture 200 to provide light L6 below the circular LED lighting fixture 200.

The can 220 is affixed to the ceiling 280 using one of a number of methods that include the use of affixing tabs (not shown). The can 220 is cylindrically shaped, as shown in FIG. 9A and FIG. 9B. Alternatively, the can 220 can have one of a number of different shapes including that of a rectangular prism or a prism with a triangular cross section. The can 220 is made from metal, plastic or a combination thereof. The can 220 includes a socket 206 for supplying power to the circular LED lighting fixture 200 through the power supply 211 received into the socket 206. The power supply 211 is electrically connected to the socket 206 by inserting it into the socket 206 as shown in FIG. 9A and FIG. 9B. The circular LED lighting fixture 200 is connected to the power supply 211 by connecting the connectors 44 and 55 of the circular LED lighting fixture 200 to the connectors 24 and 25 of the power supply 211.

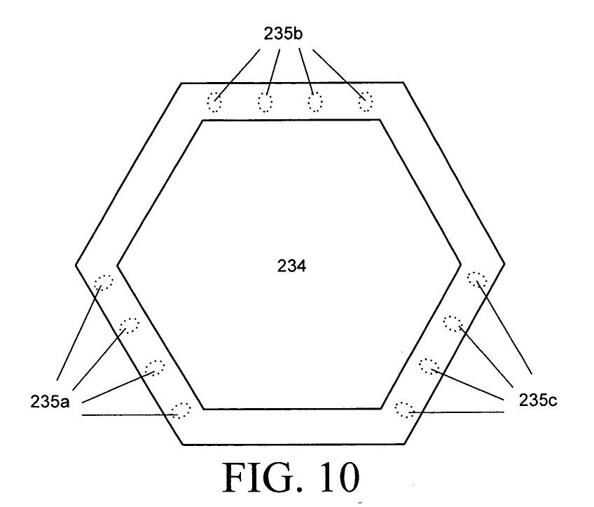

FIG. 10 is a hexagonal-shaped low-clearance light-emitting diode lighting unit according to a sixth embodiment of the invention. As shown in FIG. 10, a first set of light-emitting diodes 235a is positioned on one side of the hexagonal-shaped light-emitting diode lighting unit 234, a second set of light diodes 235b is position at a second side of the hexagonal-shaped light-emitting diode lighting unit 234, and a third set of light diodes 235c is position at a third side of the hexagonal-shaped LED lighting unit 234. Preferably, the first, second, and third sets of light-emitting diodes 235a, 235b and 235c should be on every other side of the hexagonal-shaped light-emitting diode lighting unit 234. In the alternative, the light-emitting diodes can be just on two opposing sides of the hexagonal-shaped light-emitting diode lighting unit 234.

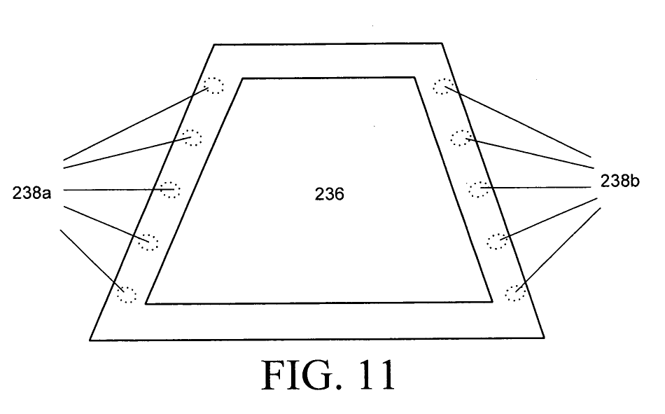

FIG. 11 is a trapezoidal-shaped low-clearance light-emitting diode lighting unit according to a seventh embodiment of the invention. As shown in FIG. 11, a first set of light-emitting diodes 238a is positioned on one side of the trapezoidal-shaped light-emitting diode lighting unit 236 and a second set of light diodes 238b is position at a second side of the trapezoidal-shaped light-emitting diode lighting unit 236. Preferably, the first and second sets of light-emitting diodes 238a and 238b should be on opposite sides of the trapezoidal-shaped light-emitting diode lighting unit 236. In the alternative, an additional set or sets of light-emitting diodes can be provided at another side or other sides to increase light output from the trapezoidal-shaped light-emitting diode lighting unit 236.

As shown by the exemplary embodiments of FIGS. 9 and 10, the light-emitting diode lighting units of embodiments of the invention can be any polygonal shape. Further, the light-emitting diode lighting units of embodiments of the invention can have a circular or an elliptical shape. Furthermore, the light-emitting diode lighting units of embodiments of the invention can have a shape that includes both a linear side and a curved side.

It will be apparent to those skilled in the art that various modifications and variations can be made to low-clearance lighting of the present invention without departing from the spirit or scope of the invention. Thus, it is intended that the present invention cover the modifications and variations of this invention provided they come within the scope of the appended claims and their equivalents.

What is claimed is:

1. A low-clearance light-emitting diode lighting, comprising:
a light guide panel having a side surface and a front surface opposing a back surface;
a plurality of light-emitting diodes positioned at the side surface of the light guide panel;
a reflecting plate at the back surface of the light guide panel;
reflector having an inclined angle; and
a metal frame for supporting the reflecting plate and the light guide panel,
wherein each of the plurality of light-emitting diodes is positioned between the side surface and the reflector such that light from the plurality of light-emitting diodes is reflected toward the side surface.

2. The low-clearance light-emitting diode lighting of claim 1, wherein the plurality of light-emitting diodes are side light-emitting diodes.

3. The low-clearance light-emitting diode lighting of claim 1, wherein the reflector and the plurality of light-emitting diodes are within the frame.

4. The low-clearance light-emitting diode lighting of claim 1, wherein the reflectors are an integral part of the reflecting plate.

5. The low-clearance light-emitting diode lighting of claim 1, further comprising heat dispersers between the plurality of light-emitting diodes and the reflecting plate.

6. The low-clearance light-emitting diode lighting of claim 1, wherein the plurality of light-emitting diodes includes one of a blue light-emitting diode and an ultraviolet light-emitting diode.

7. The low-clearance light-emitting diode lighting of claim 6, further comprising a color conversion film on a front side of the light guide panel.

8. The low-clearance light-emitting diode lighting of claim 6, further comprising color conversion films on the side surface of the light guide panel adjacent to the plurality of light-emitting diodes.

9. The low-clearance light-emitting diode lighting of claim 1, further comprising finned heatsinks on the metal frame adjacent to the plurality of light-emitting diodes positioned on the side surface of the light guide panel.

10. A low-clearance light-emitting diode lighting, comprising:
a light guide panel having a side surface and a front surface opposing a back surface;
a plurality of light-emitting diodes positioned on the side surface of the light guide panel; and
a reflective encasement having an interior reflective surface at back surface of the light guide panel and an interior reflective surface having an inclined angle,
wherein each of the plurality of light-emitting diodes is positioned between one of the side surface and the inclined interior reflective surface such that light from the plurality of light-emitting diodes is reflected toward the surface.

11. The low-clearance light-emitting diode lighting of claim 10, wherein the plurality of light-emitting diodes are side light-emitting diodes.

12. The low-clearance light-emitting diode lighting of claim 10, further comprising heat dispersers between the plurality of light-emitting diodes and the interior reflective surface.

13. The low-clearance light-emitting diode lighting of claim 10, wherein the plurality of light-emitting diodes is within the reflective encasement.

14. The low-clearance light-emitting diode lighting of claim 10, wherein the plurality of light-emitting diodes includes one of a blue light-emitting diode and an ultraviolet light-emitting diode.

15. The low-clearance light-emitting diode lighting of claim 14, further comprising a color conversion film on a front side of the light guide panel.

16. The low-clearance light-emitting diode lighting of claim 14, further comprising color conversion films on the side surface of the light guide panel adjacent to the plurality of light-emitting diodes.

17. The low-clearance light-emitting diode lighting of claim 10, further comprising finned heatsinks on the reflective encasement adjacent to the plurality of light-emitting diodes positioned on the side surfaces of the light guide panel.

18. A low-clearance light-emitting diode lighting, comprising:
a light guide panel having a side surface and a front surface opposing a back surface;
a reflecting plate at the back surface of the light guide panel;
a reflector having an inclined angle; and
a plurality of light-emitting diodes positioned on the side surface of the light guide panel and mounted on the reflecting plate,
wherein each of the plurality of light-emitting diodes is positioned between the side surface and the reflector such that light from the plurality of light-emitting diodes is reflected toward the at least two side surfaces.

19. The low-clearance light-emitting diode lighting of claim 18, wherein the plurality of light-emitting diodes are side light-emitting diodes.

20. The low-clearance light-emitting diode lighting of claim 18, wherein the reflectors are an integral part of the reflecting plate.
